(19) United States
(12) Patent Application Publication
(10) Pub. No.: US 2024/0152421 A1
(43) Pub. Date: May 9, 2024

(54) APPARATUS AND METHOD FOR SPECIFYING A DESIRED SCANNING FEATURE

(71) Applicant: Intel Corporation, Santa Clara, CA (US)

(72) Inventors: Rajesh POORNACHANDRAN, Portland, OR (US); Kaushik BALASUBRAMANIAN, Beaverton, OR (US); Karan PUTTANNAIAH, Hillsboro, OR (US)

(21) Appl. No.: 18/477,611

(22) Filed: Sep. 29, 2023

(51) Int. Cl. G06F 11/07; G06F 9/455

(52) U.S. Cl. CPC G06F 11/0793; G06F 9/45558; G06F 11/0712; G06F 2009/45591

(57) ABSTRACT

An apparatus is provided. The apparatus comprises interface circuitry, machine-readable instructions, and processing circuitry to execute the machine-readable instructions to receive a request from a virtual machine to execute a task, receive a service-level agreement, SLA, from the virtual machine indicating a desired feature of scanning a computing resource to execute the task for errors, and scan the computing resource for errors based on the SLA.

### BACKGROUND

In cloud computing, conventional scanning techniques for error detection in computing hardware have adopted a static approach to scanning settings. Service providers determine the scanning configurations once and maintain them fixed throughout the service's lifecycle. As a result, customers or end users of cloud services have no means to communicate their workload-specific error tolerance and requirements. The inflexible nature of conventional scanning techniques poses significant limitations for customers seeking to tailor their cloud-based applications to specific quality criteria. This lack of customization and adaptability can lead to suboptimal user experiences and increased total cost of ownership for service providers and customers relying on virtual machine instances.

### BRIEF DESCRIPTION OF THE FIGURES

Some examples of apparatuses and/or methods will be described in the following by way of example only, and with reference to the accompanying figures, in which

FIG. 1a and FIG. 1b illustrate an example of an apparatus for specifying a desired scanning feature;

FIG. 2 illustrates an example of a dashboard for negotiating a service-level agreement;

FIG. 3 illustrates an example of a mapping for a quality monitoring ID;

FIG. 4 illustrates an example of a register entry of a quality monitoring ID;

FIG. 5 illustrates an example of an architecture of an apparatus for specifying a desired scanning feature;

FIG. 6 illustrates an example of a method for specifying a desired scanning feature;

FIG. 7 illustrates an example of a configuration flow; and

FIG. 8 illustrates an example of an operation flow.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

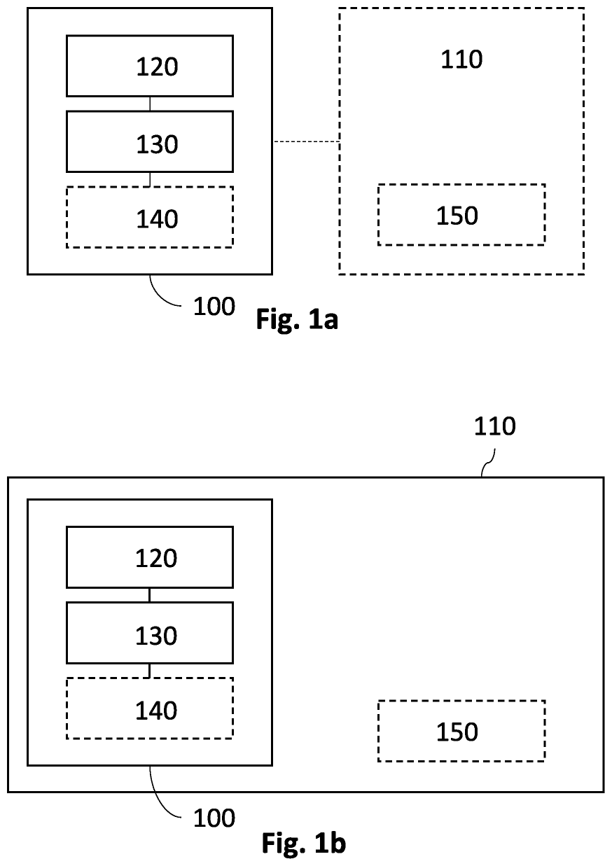

FIG. 1a shows a block diagram of an example of an apparatus 100 or device 100 communicatively coupled to a computer system 110. FIG. 1b shows a block diagram of an example of a computer system 110 comprising an apparatus 100 or device 100.

The apparatus 100 comprises circuitry that is configured to provide the functionality of the apparatus 100. For example, the apparatus 100 of FIGS. 1a and 1b comprises interface circuitry 120, processing circuitry 130 and (optional) storage circuitry 140. For example, the processing circuitry 130 may be coupled with the interface circuitry 120 and with the storage circuitry 140.

For example, the processing circuitry 130 may be configured to provide the functionality of the apparatus 100, in conjunction with the interface circuitry 120 (for exchanging information, e.g., with other components inside or outside the computer system 110) and the storage circuitry 140 (for storing information, such as machine-readable instructions).

Likewise, the device 100 may comprise means that is/are configured to provide the functionality of the device 100.

The components of the device 100 are defined as component means, which may correspond to, or implemented by, the respective structural components of the apparatus 100. For example, the device 100 of FIGS. 1a and 1b comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

In a first embodiment, the interface circuitry 120 is configured to receive a request from a virtual machine (VM) to execute a task. The interface circuitry 120 may receive the request from the computing system 110 itself or from an external device (e.g., a user device) via any communicative coupling (wired or wireless).

The VM is a software emulation of a computing system that can run applications and operating systems in an isolated environment. The VM may be a software abstraction of a physical computer that is created by a virtualization layer running on a host computer, which may be the computing system 110 or an external computing system. For instance, the host computer may have installed a virtualization layer, e.g., a hypervisor or a virtual machine monitor (VMM), in which the virtual machine is created, operated and managed. While running applications, the VM may interact with other VMs or with hardware components coupled to the computing system 110. Thereby, the VM may eventually need access to a computing resource 150 of the computing system 110 to execute the task.

The task refers to at least one unit of work or a specific job that one or more computing resource 150 or a software application is expected to perform. Tasks may be building blocks of computing processes and include processing operations, calculations, computations or functions. Tasks may be or comprise, for example, arithmetic calculations, file operations (e.g., reading, writing, copying, moving, or deleting files), data processing (e.g., analyzing and manipulating data using algorithms, such as sorting, filtering, or transforming), network communication (e.g., transmitting data packets over a network link/connection), system maintenance (e.g., conducting system updates, installing software, or running disk cleanup operations), graphic rendering (e.g., displaying images, videos, or graphical user interfaces (GUI) on a screen), computations (e.g., executing complex mathematical simulations, modeling, or data analysis) or alike.

The interface circuitry 120 is further configured to receive a service-level agreement (SLA) from the VM indicating a desired feature of scanning a computing resource 150 to execute the task for errors. The SLA refers to a contractual agreement between a service provider (the computing device 110) and its customer (the VM) that outlines specific levels of service and performance metrics that the provider is obligated to deliver. The SLA may define expectations and responsibilities of both parties regarding the quality and scope of services provided with regard to the desired feature of scanning. For instance, the SLA may provide a description of the scanning services to be provided including the scope, limitations, and any exclusions; performance metrics which quantify the scanning performance such as accuracy; escalation procedures for handling issues or disputes that may arise during the service delivery process; penalties and remedies if the service provider fails to meet the agreed-upon service levels and/or reporting and monitoring of the service performance.

The desired feature may be any characteristic of the error scanning. For example, the SLA may indicate at least one of a desired test granularity of the scanning, a desired periodicity of the scanning and an error type of the errors to be scanned for. Additionally or alternatively, the SLA may indicate whether the computing resource 150 is to be scanned for at least one of a stuck-at fault and a silent data error.

The test granularity of error scanning refers to the level of detail and scope at which errors are to be scanned for, e.g., detected and assessed during testing. It determines how finely the testing process examines the computing resource 150 for potential errors. Different levels of test granularity may include unit testing which focuses on testing individual components of the computing resource 150 in isolation, integration testing which verifies interactions between different components of the computing resource when integrated into larger modules or subsystems, system testing which evaluates the entire computing resource 150 as a whole.

The periodicity of error scanning refers to the frequency at which error scanning or testing activities are to be conducted or a number of occurrences of the scanning. It determines how often tests are executed to identify errors. Examples of periodicity options include continuous testing where the computing system 150 is to be scanned for errors continuously, scheduled testing where the scanning is to be performed at predefined time intervals or time instances, and/or iterative or regression testing where testing is to be executed when a certain trigger occurs (e.g., a certain telemetric state of the computing resource 150 or a next step in the task flow).

The error type may be any error type, e.g., hardware and/or software related errors. Software related errors may be, for example, corrupted data when the content of a file, database record, or data block becomes altered or invalid due to a storage media failure, transmission errors, or other hardware-related issues; a bit flip when a single binary digit (bit) in a data stream is altered due to electrical or magnetic interference; data loss referring to the unintended removal of data; duplicated data when the same information is stored multiple times leading to inconsistency or conflicts during data retrieval or updates; data inconsistency when the same data element has different values across different databases or alike. Hardware related errors may be a stuck-at fault when a signal in a digital circuit is stuck at a specific logic value (0 or 1) due to defects in transistors or interconnections; a transient fault which is a temporary error that occurs in electronic components due to external factors like cosmic radiation or electromagnetic interference; a permanent fault which may result from manufacturing defects, wear-out of electronic components over time, or physical damage to hardware; overheating or thermal fault; memory errors such as single-bit or multi-bit errors due to memory cell degradation or alike.

In some examples, the error type may be at least one of a stuck-at fault (as explained above), an at-speed fault and a silent data error. An at-speed fault is a type of error that occurs in digital circuits when they are operating at their normal or specified operating frequency. A silent data error refers to an undetected or unreported error that occurs in computer data storage, processing, or transmission. Silent data errors may be caused by various factors, including bit-flip errors, cosmic radiation, aging and wear-out of electronic components, electromagnetic interference, and software bugs.

The computing resource 150 may be any hardware or software component that contributes to the functioning, processing, or execution of tasks in the computing environment of the computing system 110. It may be physical hardware or a virtual entity. The computing resource 150 may be or comprise a processing core, memory, an interconnect link, a processor and a processing platform. Additionally or alternatively, the computing resource 150 may be or comprise a central processing unit (CPU), random access memory, a storage device, a graphics processing unit, a networking device, an input and output device, cloud computing services, software libraries and frameworks, a power supply unit, a system bus or interconnect or alike.

The processing circuitry 130 is configured to scan the computing resource 150 for errors based on the SLA. For example, the processing circuitry 130 may scan the computing resource 150 at least as specified by the SLA, e.g., in terms of error types, test granularity etc. The processing circuitry 130 may therefore adjust scanning settings for the computing resource 150 and scan the computing resource 150 with the adjusted scanning settings. The scanning of the computing resource 150 may be executed during execution of the task and/or beforehand. For instance, if the scanning is done before execution of the task, the scanning results may be used to predict a quality of service (QoS) achievable for the execution of the task with the computing resource 150. The scanning results may additionally or alternatively be used to determine an appropriate computing resource 150 which fulfills an expected QoS regarding a number of errors, e.g., indicated by the SLA, and execute the task on the determined computing resource. The scanning results may additionally or alternatively be used to schedule the computing resource 150 in order to fulfill the expected QoS regarding a number of errors. If the scanning is done during execution of the task by the computing resource 150, the scanning results may be used to track an actually achieved QoS or take measures if a certain level of errors is exceeded (as explained further below).

Silent data errors (SDE) or other errors, e.g., due to random manufacturing defects in silicon or hardware defects, may violate the computational integrity. SDE incidents are viewed at same level of severity as security vulnerability. The impact is to VMs and applications hosted on the public cloud (computing system 110). Therefore, quality as measured by avoidance of SDE may be a desired metric for cloud service providers (CSP, the computing system 110) and end users (the VM). There may be software and hardware screens that can be initiated by a fleet operator (the computing system 110) on a given node (computing resource 150) to screen defective computing resources prior to exposing the task of the VM to SDE.

However, conventional techniques are completely static in their scanning settings: For example, the service provider may determine these scanning settings once and keep it fixed. That is, there is no way for customers or end users of a public cloud service to convey their workload (or task) specific quality tolerance profile and requirements (SLA in terms of scanning errors) or to obtain appropriate VM instance (computing resource 150) that can meet these specifications (SLA). This may lead to poor user experience or total cost of ownership when customers/users/developers using the VM instance don't have any means to specify the expected quality criteria for their workload (task) of choice and don't get a guarantee to meet those criteria.

By contrast, the apparatus 100 may provide a “quality monitoring and enforcing technology (QMET) for on-demand servicing of quality requirements per user/VM” that addresses the above challenge. The apparatus 100 may enable dynamic negotiation and adaptation of scanning settings via the SLA.

The scanning of errors may be based on any error detection technique. For example, the processing circuitry 130 may scan the computing resource 150 using at least one of an array in-field scan, an array built-in self test (BIST) and an at-speed fault detection. An array In-Field Scan (IFS) is a technique used in semiconductor testing to detect and diagnose faults or defects in the computing resource 150 (e.g., in memory arrays) which takes place in the operational environment of the computing resource 150. The array in-field scan may involve selectively activating built-in test structures within the memory array to identify and locate faults that may arise during the device's lifetime. The array in-field scan may further involve the use of specialized test patterns and test algorithms that can access and analyze specific memory cells or segments of the memory array. By conducting in-field scans periodically or on-demand, the processing circuitry 130 may identify and address memory faults that may have developed due to various factors, such as wear and tear, aging, or environmental conditions.

An array BIST is a hardware-based self-testing mechanism integrated into the computing resource 150 (e.g., into memory arrays, processors, or other integrated circuits). BIST allows the circuitry to perform self-testing and fault detection without the need for external test equipment. During the manufacturing process, BIST structures are added to the design of the integrated circuit to facilitate on-chip testing. When the BIST is executed/activated, the circuit initiates self-testing procedures to evaluate the functional integrity of the memory array or specific components. The BIST generates test patterns, applies them to the circuit, and analyzes the responses to identify potential faults or defects.

An at-speed fault detection is a type of testing technique used to identify faults in the computing resource 150 (e.g., digital circuits or systems) while they are operating at their intended or specified clock frequency. Unlike conventional testing methods, which may test circuits at slower clock speeds, at-speed fault detection may ensure that potential faults and timing-related issues are identified and addressed when the circuit is running at its normal operational speed. Unlike traditional testing methods, which often test circuits at slower speeds, at-speed testing may ensure that the circuit is free from errors that may not be evident at lower clock frequencies.

Depending on the desired granularity of testing, the processing circuitry 130 may scan the computing resource 150 at a certain level, for example, at intra-component-level (processing core), component-level (memory, interconnect link, processor) or at platform-level (processing platform) for respective errors based on the SLA. For example, an in-field scan may be run individually on each core of a processor which may take 200 milliseconds. In this manner, a failure in a single core does not necessarily require an entire CPU socket to be brought down—instead other cores can still be used which may lead to higher fleet utilization and total cost of ownership advantages.

As mentioned above, the requirements indicated by the SLA may be used for selecting an appropriate computing resource to execute the task. For example, the SLA may further indicate a tolerated level (number) of errors of the task, e.g., a tolerated level for each of different error types. For instance, some applications/VMs (e.g., critical applications) may be more sensitive to hardware errors, while others may be more tolerant to errors. The processing circuitry 130 may assign the computing resource 150 to the task based on said tolerated level of errors. For example, the processing circuitry 130 may select the computing resource 150 from a plurality of resources which expectedly can meet the requirement of the tolerated level of errors. That is, a prediction about the expected QoS of the computing resource 150 is made, e.g., based on historical data about occurrences of errors associated with the computing resource 150 and/or an error model considering usage or aging effects. This prediction is compared to the tolerated level of errors and searched for matches. If a matching computing resource (150) is found, the processing circuitry 130 may assign this computing resource 150 to the task, e.g., by adding the task to the scheduling of that computing resource 150.

A dynamic approach may be a negotiation of a computing resource (150). For example, the SLA may indicate the tolerated level of errors of the task. And the processing circuitry 130 may dynamically negotiate, with the virtual machine, the computing resource 150 to be assigned to the task based on the tolerated level of errors. For example, the apparatus 100 may provide a QMET user dashboard where additional filter fields for customers/VMs expose the quality attributes (predicted QoS) of a VM instance (computing resource 150) offering and obtaining inputs on the criteria. The fields that require a feasibility check are fed dynamically to a quality assessor module of the apparatus 100 showing feedback to the VM as to whether input field is valid/feasible with the computing resource 150. The QMET quality assessor module may be a firmware component that can run on hypervisor or on platform BMC (baseboard management controller) for fleet-level management to evaluate the feasibility of meeting the quality level (e.g., the tolerated level of errors) and perform required quality (error) screens as per the quality level for the given hardware/software platform configuration (selected computing resource 150) to generate variety of platform quality profiles. In an example, a register in BMC at platform level or MSR (model specific register) at SoC (system-on-chip) level can be used to host information about XPU (X processing unit, processing unit of any architecture) available, scan granularity, application migration (as explained further below), etc.

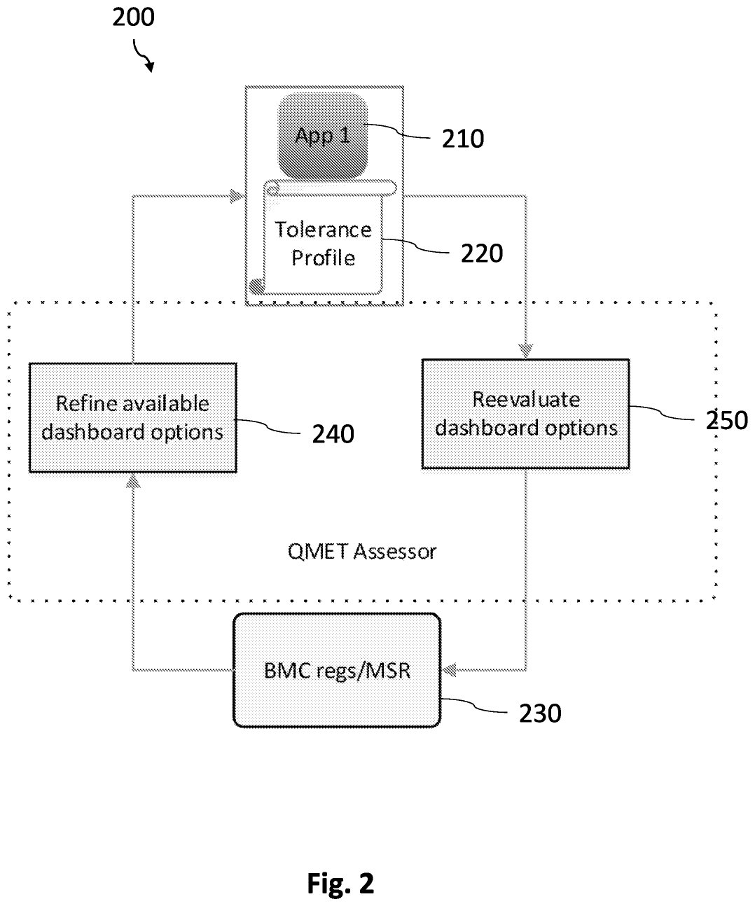

An example of such a dashboard is illustrated by FIG. 2. FIG. 2 shows an example of a negotiation process 200 between an apparatus as described herein (e.g., apparatus 100) and a virtual machine. The VM requests execution of a task 210, e.g., an application (App 1), and defines an SLA 220 indicating a tolerance profile including, e.g., a tolerated level of errors. The apparatus provides a BMC register or MSR 230 which executes a QMET assessor module. Based on the SLA 220, the BMC register or MSR 230 may expose or refine available dashboard options, e.g., the features of error scanning or measure to be taken in case of errors that can be selected or defined by the VM. The VM then evaluates or reevaluates the dashboard options and sends the evaluation to the BMC register or MSR 230. The negotiation process 200 may be repeated until both parties agree on certain scanning settings and/or measures to be taken in case of errors. Some critical applications (tasks) may be sensitive to data errors, requiring stringent hardware scan and defect detection policies. The dashboard may provide a set of filter fields (quality tolerance profile) to expose the quality attributes of an application/VM instance (computing resource 150). The user (VM) is provided a dashboard to select the quality attributes among available choices based on the user's quality requirements.

Referring back to FIG. 1a and FIG. 1b, the processing circuitry 130 may assign the computing resource 150 to the task using, e.g., a QMET quality mapper module. Based on assessed quality profile (expected QoS achievable by the computing resource 150), the processing circuitry 150 may create an associated logical construct called a QMID (quality monitoring identifier) dynamically and identify a well-suited or the bast quality level (QL) based on the tolerance profile (tolerated level of errors) specified by the VM. For example, an association of Application/VM with an QMID via a Hypervisor/VMM may be done using a processor MSR. Each logical processor may then have an associated QMID and application ID. The QMID may be used to map the task and in turn the computing resource 150 to a QoS to be achieved. The application ID may be used to associate the computing resource 150 to a task (App/VM) being run on the computing resource 150.

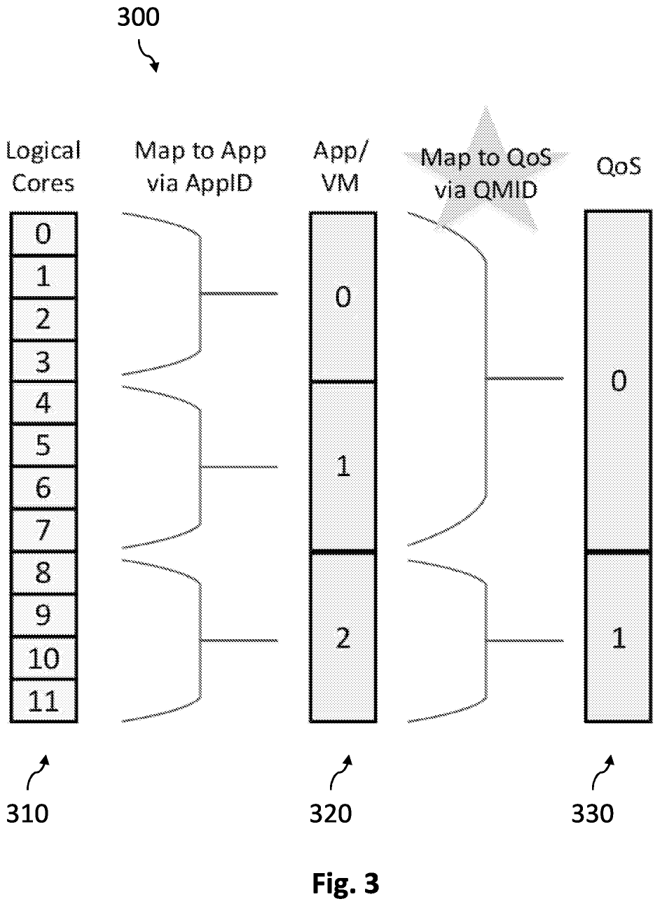

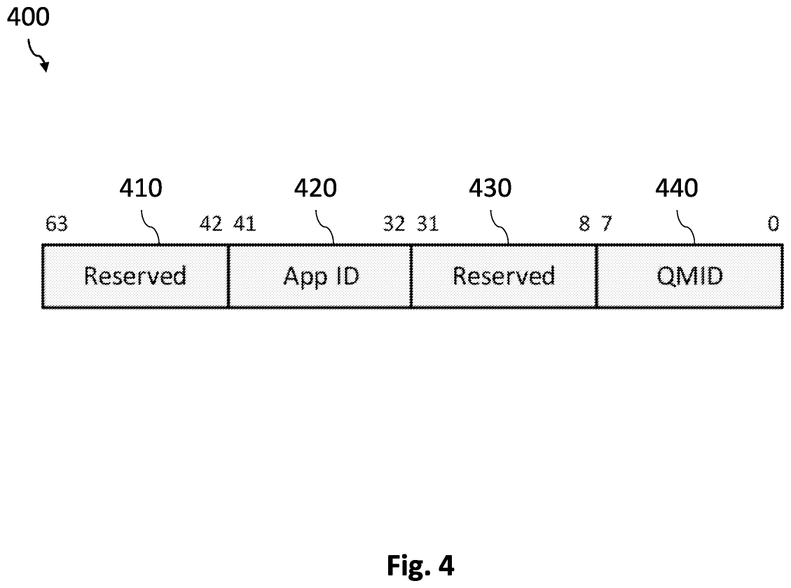

An example of a QMID mapping 300 and an example of a QMID register entry 400 are illustrated by FIG. 3 and FIG. 4, respectively. The QMID mapping 300 includes mapping logical cores 310 of a computing resource to a respective task (application) of a plurality of tasks 320 by associating a task ID (application ID) to the logical cores 310. Further, the QMID mapping 300 includes mapping the tasks 320 to a respective QoS level 330 by associating a QMID to the tasks 320. The QMID register entry 400 may be an MSR register entry which associates tasks 430 to a computing resource 410 via a task ID 420 and tasks 430 to a QoS level via a QMID 440. For example, a logical processor may have an associated QMID and application ID. The QMID may map the task and in turn the core to QoS. The application ID may associate the core with a task being run on the core.

Referring back to FIG. 1a and FIG. 1b, additional quality attributes may be specified by the SLA. For example, the SLA may further indicate a desired on-die location of a processing core of the computing resource 150 to execute the task. The processing circuitry 130 may be configured to assign the computing resource 150 to the task based on the desired on-die location of the processing core. The location of the core may be, e.g., middle or edge of the hardware die. The specification of the location may be an additional quality attribute that can be requested by the VM. The SLA may additionally or alternatively indicate whether the task tolerates sharing a processing core. The processing circuitry 130 may then be configured to execute the task using hyperthreading or not based on the SLA.

An example of an SLA or scan profile may specify the following:
1) Urgency of detection: Certain critical tasks (applications) may be sensitive to SDEs which can cause data corruption within short span of time, leading to undesirable outcomes. Temporal requirements on periodicity of hardware scan can be specified. For example, the user (VM) may specify desired tests/scans per hour within the available range specified by CSP (the computing system 110). This can help catch and contain the error, with optional policy-based action taken.
2) Granularity of test: Scanning defects at different components of hardware of the computing resource 150 are brought about by using different test blobs. For more robust scans, fine granular tests need to be run. For example, the user (VM) can select the granularity of scans ranging from low granularity to high granularity depending on the criticality/tolerance of the application (task).
3) Parallel scan for defects on multiple cores: Applications (tasks) that can tradeoff continuous usage (idle time) with robust and frequent scans can tolerate running scans in parallel on multiple cores.
4) Primary XPU device: The user (VM) can provide an input on what the primary/critical device (computing resource 150) is that the application (task) is using, so that the scan can be prioritized on the particular device. For example, an application running deep learning on discrete graphics processing unit (GPU) can specify the GPU as primary and CPU as secondary.
5) Sharing logical cores: The user (VM) has the capability to specify whether the task is tolerant to sharing logical cores of same physical core (of the computing resource 150) with other VMs.

As mentioned above, the SLA may also specify measures to be taken during execution of the task. For example, the SLA may further indicate whether the task is to be migrated or restored when an error is detected during execution of the task. The processing circuitry 130 may be configured to at least partially migrate or restore the task when an error is detected based on the SLA, e.g., as indicated by the SLA.

The QoS level specified by the SLA may then be enforced for the task associated with a QMID by the processing circuitry 130, for instance. The apparatus 100 may, e.g., include a QMET quality enforcer module which may adapt the scheduling and scanning settings of the computing resource 150 based on the SLA, and may set an interrupt when a predefined level of errors is detected in order to take a measure specified in the SLA.

An example of such measures (policy-based action upon scan) may specify the following:
1) Application migration: Upon detection of a defect, application (task) might have to be migrated to a different location (processing core) within or outside the node (computing resource 150). Tolerance to migrating outside the node can be specified by the SLA.
2) Restoring to new state: Users (VM) can specify what action to take upon detection of defect in terms of reverting the application (task) state. Critical applications can prefer reverting the state to last successful in-field scan. On the other hand, non-critical applications can prefer continuing in same state at the time of detection in order to lower the application downtime.

The Enforcer Module may optionally track appropriate run-time telemetry such as scan results and operating conditions of the computing resource 150 for the determined quality level QL for record keeping, future improvement and auditability. For example, the processing circuitry 130 may be configured to store the scanned errors of the computing resource 150, e.g., in the storage device 140. The processing circuitry 130 may further be configured to store, e.g., in the storage device 140, a telemetry of the computing resource 150 and generate an error profile of the computing resource 150 based on the scanned errors and the telemetry.

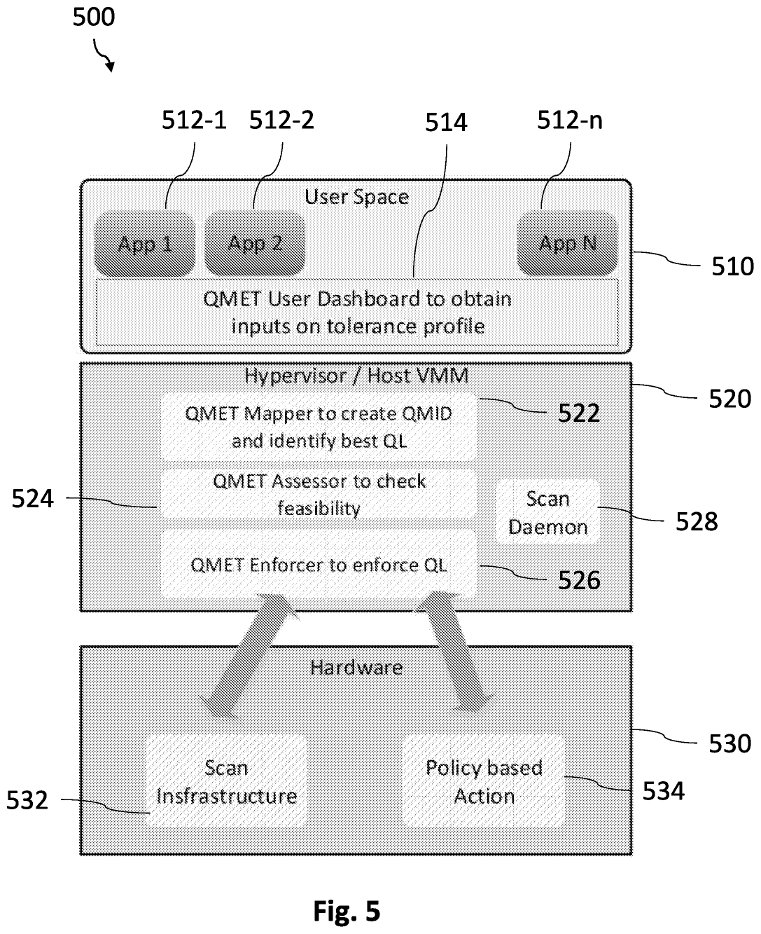

FIG. 5 illustrates an example of an architecture 500 (e.g., QMET architecture) of an apparatus as described herein, such as apparatus 100. The architecture 500 includes a user space 510. The user space 510 refers to a portion of memory where tasks 512-1 to 512-n such as user-level applications, processes, and user-mode code execute, usually with limited privileges and isolated from other memory areas. The user space 510 further executes a user dashboard 514 to obtain an SLA regarding a desired feature of scanning a computing resource for errors and optionally regarding other quality features or measures to be taken when a predefined level of errors is exceeded.

The architecture 500 further includes a hypervisor 520 (or host VMM). The hypervisor 520 executes a QMET mapper (module) 522, a QMET assessor (module) 524, a QMET enforcer (module) 526 and a scan daemon 528. The scan daemon 528 is a background service or process that runs on a computing system and is responsible for managing and coordinating scanning operations. The architecture 500 further includes hardware 530. The hardware 530 includes scan infrastructure 532 and hardware to enforce policy-based actions 534.

Referring back to FIG. 1a and FIG. 1b, in a second embodiment, the processing circuitry 130 is configured to determine a respective achievable quality of service, QoS, of a plurality of computing resources 150 in terms of a capability to scan the computing resources 150 for errors. The processing circuitry 130 is further configured to associate a task to be executed having a predefined QoS requirement to at least one of the plurality of computing resources 150 based on the achievable QoS.

For example, the processing circuitry 130 may be configured to associate the computing resource 150 and a virtual machine requesting an execution of the task to a QoS identifier indicating the predefined QoS requirement and set a monitoring of the computing resource 150 for meeting the predefined QoS requirement. The processing circuitry 130 may then execute the task by the computing resources 150 with the set monitoring. Optionally, the processing circuitry 140 may track an actual QoS during the execution of the task by the computing resource through scanning the computing resources 150 for errors and store the tracked actual QoS. For instance, the processing circuitry 130 may scan the computing resources 150 for errors using a runtime or in-field scan. The computing resources 150 may comprise or be at least one of a processing core, memory, an interconnect link, a processor and a processing platform. The achievable QoS may indicate a capability to scan the computing resources 150 for at least one of a stuck-at fault and a silent data error.

The second embodiment is combinable with the first embodiment or with features of the first embodiment.

A specific example of the apparatus 100 may include a firmware component that can assess the quality of a computing resource 150 (CPU/XPU) in terms of number of SDEs in the processing cores, memory errors, interconnect link errors, etc. The processing circuitry 130 may scan the computing resource 150, e.g., at runtime and/or by an in-field scan to assess the quality of the platform ingredients. Based on the assessed quality and a tolerance of a task to hardware errors, the processing circuitry 130 may derive a QMID. The QMID may have the following structure:
Struct Quality_Monitoring_ID_QMID {
uint_8 XPU_ID; an identifier of the computing resource 150;
uint_32 XPU_COMPUTE_CORES_SDE_TOLERANCE; a tolerance to hardware errors of compute cores;
uint_32 XPU_MEMORY_SDE_TOLERANCE; a tolerance to hardware errors of memory;
uint_32 XPU_INTERCONNECT_SDE_TOLERANCE; a tolerance to hardware errors of interconnect links;
uint_32 XPU_COMPUTE_CORES_SDE_DETECTED; detected errors in the compute cores;
uint_32 XPU_MEMORY_SDE_DETECTED; detected errors in the memory;
uint_32 XPU_INTERCONNECT_SDE_DETECTED; detected errors in the interconnect links;
Reserved;
};

The QMID may provide the capability to track the observed SDEs in association with an allowed tolerance level.

In this specific example, the apparatus 100 may include a QMET enforcer module which is a firmware component to enforce configured QMID for a VM at run-time that can be augmented to a resource director technology. The apparatus 100 may further have the capability to assess and continuously monitor the quality level of a VM in each XPU configuration and define the quality of VMs based on user requirements. A cloud VM migration may use the quality profiles for specific VM as part of VM migration towards identifying optimal VM placement strategy based on quality as criteria. The apparatus 100 may enable in-band (at SoC-level) and out-of-band (at platform-level) telemetry for quality level monitoring and record keeping. The enforcer module may track run-time telemetry such as scan results and operating conditions of the computing resource 150 for each quality level for record keeping, future improvement and auditability.

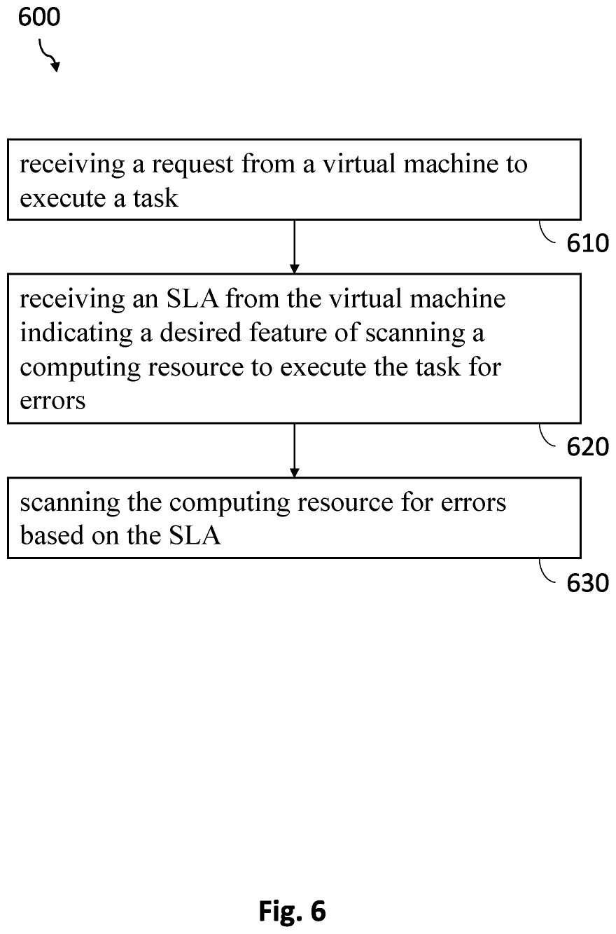

FIG. 6 illustrates a flowchart of an example of a method 600. The method 600 may be executed by an apparatus as described herein, such as apparatus 100. The method 600 comprises receiving 610 a request from a virtual machine to execute a task, receiving 620 an SLA from the virtual machine indicating a desired feature of scanning a computing resource to execute the task for errors and scanning 630 the computing resource for errors based on the SLA.

More details and aspects of the method 600 are explained in connection with the proposed technique or one or more examples described above (e.g., FIGS. 1a and 1b). The method 600 may comprise one or more additional optional features corresponding to one or more aspects of the proposed technique, or one or more examples described above.

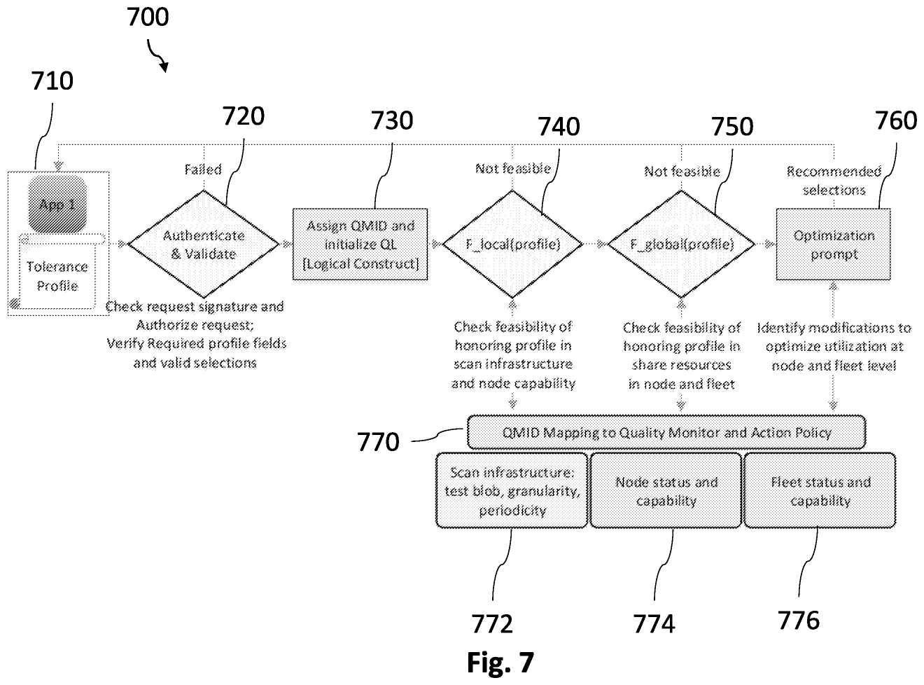

FIG. 7 illustrates a flowchart of an example of a configuration flow 700. In a first block 710, the task (user/application) specifies a tolerance configuration through a user dashboard based on sensitivity to errors, application migration options, primary XPU device, etc. prior to task being created. Furthermore, the dashboard may include fields to authenticate the user. In a second block 20, the authenticity and the tolerance configuration of the task is validated: For example, the authenticity may be checked via a digital signature, e.g., it is checked whether the signature and checksum of input from dashboard are valid. If the check fails, the VM is notified and prompted to verify authenticity. It is further checked for required fields and valid entries: Each configuration parameter may have an allowed set of entries that the task specification may be validated against dynamically. Allowed set of parameters are based on service provider requirements. For example, tasks requesting finer granularity of tests may be limited to certain computing resources (nodes) restricting migration.

In a third block 730, a QMET mapper module assigns a QMID to the task and initializes the quality level. Based on the feasibility and optimization updates, the quality level is assigned. In a fourth block 740, a QMET assessor module checks the feasibility at application level. For example, urgency of detection(periodicity), test blob granularity, restoring to new state, primary XPU device, etc. may be checked. If passed, a local tolerance profile is set via QMID.

In a fifth block 750, a QMET assessor module checks the feasibility at node and datacenter level. For example, a tolerance to node-to-node migration, sharing logical cores with other VMs, etc. is checked. If passed, a global tolerance profile is set via QMID. In a sixth block 760, the feasibility checks are completed, and the QMET assessor module identifies optimizations and chooses the quality level for the application based on service provider requirements and user inputs.

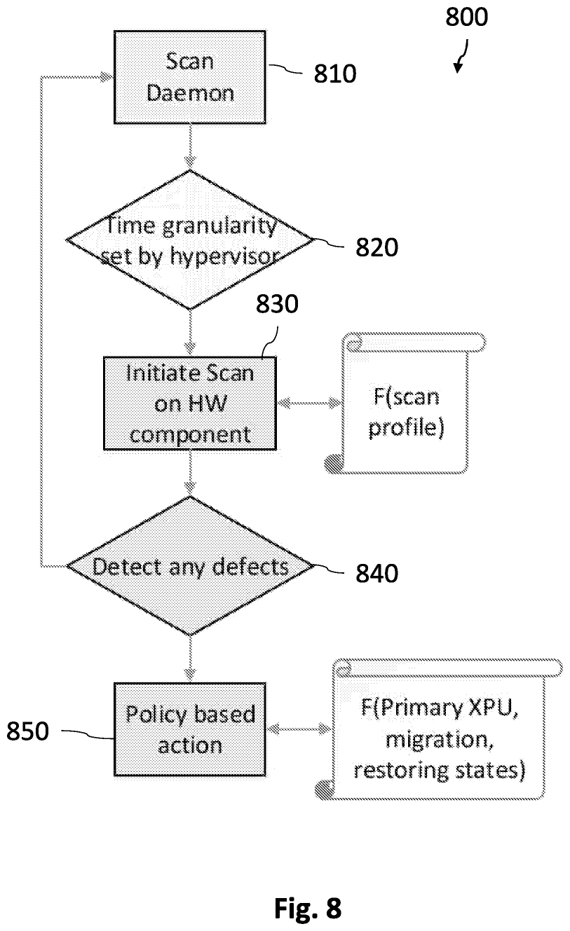

FIG. 8 illustrates a flowchart of an example of an operation flow 800. In a first block 810, a QMET enforcer module may enforce a quality level for a given task with associated QMID via a scan daemon. Based on the quality level, the enforcer dynamically determines, in a second block 820, scan parameters such as test blobs and schedule the scans accordingly. In a third block 830, the QMID is used to direct the scan through firmware to computing resources associated with a VM of the task. If a defect is detected in a fourth block 840, the enforcer takes policy-based actions according to a fifth block 850, such as initiating application migration and/or restoring to new state. Further, the enforcer module may track appropriate run-time telemetry such as scan results and operating conditions of the platform for each quality level for record keeping, future improvement and auditability.

Apparatuses and methods described herein may provide a “quality monitoring and enforcing technology for on-demand servicing of quality requirements per user/VM”. The apparatuses and methods may enable dynamic negotiation and adaptation of scanning settings via an SLA.

In the following, some examples of the proposed concept are presented:
An example (e.g., example 1) relates to an apparatus, the apparatus comprising interface circuitry, machine-readable instructions, and processing circuitry to execute the machine-readable instructions to receive a request from a virtual machine to execute a task, receive a service-level agreement, SLA, from the virtual machine indicating a desired feature of scanning a computing resource to execute the task for errors, and scan the computing resource for errors based on the SLA.

Another example (e.g., example 2) relates to a previous example (e.g., example 1) or to any other example, further comprising that the SLA indicates at least one of a desired test granularity of the scanning, a desired periodicity of the scanning and an error type of the errors to be scanned for.

Another example (e.g., example 3) relates to a previous example (e.g., one of the examples 1 or 2) or to any other example, further comprising that the SLA indicates whether the computing resource is to be scanned for at least one of a stuck-at fault and a silent data error.

Another example (e.g., example 4) relates to a previous example (e.g., one of the examples 1 to 3) or to any other example, further comprising that the machine-readable instructions comprise instructions to scan at least one of a processing core, memory, an interconnect link, a processor and a processing platform for respective errors based on the SLA.

Another example (e.g., example 5) relates to a previous example (e.g., one of the examples 1 to 4) or to any other example, further comprising that the machine-readable instructions comprise instructions to scan the computing resource using an array built-in self test.

Another example (e.g., example 6) relates to a previous example (e.g., one of the examples 1 to 5) or to any other example, further comprising that the SLA further indicates a tolerated level of errors of the task, and wherein the machine-readable instructions comprise instructions to assign the computing resource to the task based on the tolerated level of errors.

Another example (e.g., example 7) relates to a previous example (e.g., one of the examples 1 to 6) or to any other example, further comprising that the SLA further indicates a tolerated level of errors of the task, and wherein the machine-readable instructions comprise instructions to dynamically negotiate, with the virtual machine, a computing resource to be assigned to the task based on the tolerated level of errors.

Another example (e.g., example 8) relates to a previous example (e.g., one of the examples 1 to 7) or to any other example, further comprising that the SLA further indicates a desired on-die location of a processing core to execute the task, wherein the machine-readable instructions comprise instructions to assign the computing resource to the task based on the desired on-die location of the processing core.

Another example (e.g., example 9) relates to a previous example (e.g., one of the examples 1 to 8) or to any other example, further comprising that the SLA further indicates whether the task is to be migrated or restored when an error is detected during execution of the task, wherein the machine-readable instructions comprise instructions to at least partially migrate or restore the task when an error is detected based on the SLA.

Another example (e.g., example 10) relates to a previous example (e.g., one of the examples 1 to 9) or to any other example, further comprising that the machine-readable instructions comprise instructions to execute the task using hyperthreading based on the SLA.

Another example (e.g., example 11) relates to a previous example (e.g., one of the examples 1 to 10) or to any other example, further comprising that the machine-readable instructions comprise instructions to store the scanned errors of the computing resource.

Another example (e.g., example 12) relates to a previous example (e.g., example 11) or to any other example, further comprising that the machine-readable instructions further comprise instructions to store a telemetry of the computing resource and generate an error profile of the computing resource based on the scanned errors and the telemetry.

An example (e.g., example 13) relates to a method, comprising receiving a request from a virtual machine to execute a task, receiving a service-level agreement, SLA, from the virtual machine indicating a desired feature of scanning a computing resource to execute the task for errors, and scanning the computing resource for errors based on the SLA.

Another example (e.g., example 14) relates to a previous example (e.g., example 13) or to any other example, further comprising scanning at least one of a processing core, a processor and a processing platform for respective errors based on the SLA.

Another example (e.g., example 15) relates to a previous example (e.g., one of the examples 13 or 14) or to any other example, further comprising scanning the computing resource using an array built-in self test.

Another example (e.g., example 16) relates to a previous example (e.g., one of the examples 13 to 15) or to any other example, further comprising that the SLA further indicates a tolerated level of errors of the task, and the method further comprising assigning the computing resource to the task based on the tolerated level of errors.

Another example (e.g., example 17) relates to a previous example (e.g., one of the examples 13 to 16) or to any other example, further comprising that the SLA further indicates a tolerated level of errors of the task, and the method further comprising dynamically negotiating, with the virtual machine, a computing resource to be assigned to the task based on the tolerated level of errors.

Another example (e.g., example 18) relates to a previous example (e.g., one of the examples 13 to 17) or to any other example, further comprising that the SLA further indicates a desired on-die location of a processing core to execute the task, and the method further comprising assigning the computing resource to the task based on the desired on-die location of the processing core.

Another example (e.g., example 19) relates to a previous example (e.g., one of the examples 13 to 18) or to any other example, further comprising that the SLA further indicates whether the task is to be migrated or restored when an error is detected during execution of the task, and the method comprising at least partially migrating or restoring the task when an error is detected based on the SLA.

An example (e.g., example 20) relates to an apparatus, the apparatus comprising interface circuitry, machine-readable instructions, and processing circuitry to execute the machine-readable instructions to determine a respective achievable quality of service, QoS, of a plurality of computing resources in terms of a capability to scan the computing resources for errors, and associate a task to be executed having a predefined QoS requirement to at least one of the plurality of computing resources based on the achievable QoS.

Another example (e.g., example 21) relates to a previous example (e.g., example 20) or to any other example, further comprising that the machine-readable instructions comprise instructions to associate the computing resources and a virtual machine requesting an execution of the task to a QoS identifier indicating the predefined QoS requirement, set a monitoring of the computing resources for meeting the predefined QoS requirement, and execute the task by the computing resources with the set monitoring.

Another example (e.g., example 22) relates to a previous example (e.g., example 21) or to any other example, further comprising that the machine-readable instructions comprise instructions to track an actual QoS during the execution of the task by the computing resources through scanning the computing resources for errors, and store the tracked actual QoS.

Another example (e.g., example 23) relates to a previous example (e.g., example 22) or to any other example, further comprising that the machine-readable instructions comprise instructions to scan the computing resources for errors using a runtime or in-field scan.

Another example (e.g., example 24) relates to a previous example (e.g., one of the examples to 23) or to any other example, further comprising that the computing resources comprises at least one of a processing core, memory, an interconnect link, a processor and a processing platform.

Another example (e.g., example 25) relates to a previous example (e.g., one of the examples to 24) or to any other example, further comprising that the achievable QoS indicates a capability to scan the computing resources for at least one of a stuck-at fault and a silent data error.

An example (e.g., example 26) relates to a method, comprising determining a respective achievable quality of service, QoS, of a plurality of computing resources in terms of a capability to scan the computing resources for errors, and associating a task to be executed having a predefined QoS requirement to at least one of the plurality of computing resources based on the achievable QoS.

Another example (e.g., example 27) relates to a non-transitory machine-readable storage medium including program code, when executed, to cause a machine to perform the method of any one of examples 13 to 19 or the method of example 26.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means.

Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus, the apparatus comprising interface circuitry, machine-readable instructions, and processing circuitry to execute the machine-readable instructions to:
receive a request from a virtual machine to execute a task;
receive a service-level agreement, SLA, from the virtual machine indicating a desired feature of scanning a computing resource to execute the task for errors; and
scan the computing resource for errors based on the SLA.

2. The apparatus of claim 1, wherein the SLA indicates at least one of a desired test granularity of the scanning, a desired periodicity of the scanning and an error type of the errors to be scanned for.

3. The apparatus of claim 1, wherein the SLA indicates whether the computing resource is to be scanned for at least one of a stuck-at fault and an at-speed fault a.

4. The apparatus of claim 1, wherein the machine-readable instructions comprise instructions to scan at least one of a processing core, memory, an interconnect link, a processor and a processing platform for respective errors based on the SLA.

5. The apparatus of claim 1, wherein the machine-readable instructions comprise instructions to scan the computing resource using an array built-in self test.

6. The apparatus of claim 1, wherein the SLA further indicates a tolerated level of errors of the task, and wherein the machine-readable instructions comprise instructions to assign the computing resource to the task based on the tolerated level of errors.

7. The apparatus of claim 1, wherein the SLA further indicates a tolerated level of errors of the task, and wherein the machine-readable instructions comprise instructions to dynamically negotiate, with the virtual machine, a computing resource to be assigned to the task based on the tolerated level of errors.

8. The apparatus of claim 1, wherein the SLA further indicates a desired on-die location of a processing core to execute the task, wherein the machine-readable instructions comprise instructions to assign the computing resource to the task based on the desired on-die location of the processing core.

9. The apparatus of claim 1, wherein the SLA further indicates whether the task is to be migrated or restored when an error is detected during execution of the task, wherein the machine-readable instructions comprise instructions to at least partially migrate or restore the task when an error is detected based on the SLA.

10. The apparatus of claim 1, wherein the machine-readable instructions comprise instructions to execute the task using hyperthreading based on the SLA.

11. The apparatus of claim 1, wherein the machine-readable instructions comprise instructions to store the scanned errors of the computing resource.

12. The apparatus of claim 11, wherein the machine-readable instructions further comprise instructions to store a telemetry of the computing resource and generate an error profile of the computing resource based on the scanned errors and the telemetry.

13. A method, comprising:
receiving a request from a virtual machine to execute a task;
receiving a service-level agreement, SLA, from the virtual machine indicating a desired feature of scanning a computing resource to execute the task for errors; and
scanning the computing resource for errors based on the SLA.

14. The method of claim 13, wherein the SLA further indicates whether the task is to be migrated or restored when an error is detected during execution of the task, and the method comprising at least partially migrating or restoring the task when an error is detected based on the SLA.

15. An apparatus, the apparatus comprising interface circuitry, machine-readable instructions, and processing circuitry to execute the machine-readable instructions to:
determine a respective achievable quality of service, QoS, of a plurality of computing resources in terms of a capability to scan the computing resources for errors; and
associate a task to be executed having a predefined QoS requirement to at least one of the plurality of computing resources based on the achievable QoS.

16. The apparatus of claim 15, wherein the machine-readable instructions comprise instructions to:
associate the computing resources and a virtual machine requesting an execution of the task to a QoS identifier indicating the predefined QoS requirement;
set a monitoring of the computing resources for meeting the predefined QoS requirement; and
execute the task by the computing resources with the set monitoring.

17. The apparatus of claim 16, wherein the machine-readable instructions comprise instructions to:
track an actual QoS during the execution of the task by the computing resources through scanning the computing resources for errors; and
store the tracked actual QoS.

18. The apparatus of claim 17, wherein the machine-readable instructions comprise instructions to scan the computing resources for errors using a runtime or in-field scan.

19. The apparatus of claim 15, wherein the achievable QoS indicates a capability to scan the computing resources for at least one of a stuck-at fault and a silent data error.

20. The apparatus of claim 17, wherein the machine-readable instructions comprise instructions to scan at least one of a processing core, memory, an interconnect link, a processor and a processing platform for respective errors based on the SLA.
